(19) United States
(12) Patent Application Publication
(10) Pub. No.: US 2017/0173371 A1
(43) Pub. Date: Jun. 22, 2017

(54) Respirator Seals

(71) Applicant: Nextteq LLC, Tampa, FL (US)

(72) Inventors: Bryan I. Truex, Tampa, FL (US); Gueorgui M. Mihaylov, Virginia Beach, VA (US)

(73) Assignee: Nextteq LLC, Tampa, FL (US)

(21) Appl. No.: 15/386,348

(22) Filed: Dec. 21, 2016

Related U.S. Application Data
(60) Provisional application No. 62/270,110, filed on Dec. 21, 2015.

(51) Int. Cl. A62B 18/02; B29C 67/00; G06F 17/50; B33Y 50/02; B33Y 80/00; A62B 9/02; B33Y 10/00

(52) U.S. Cl. CPC A62B 18/02; A62B 9/02; B29C 67/0088; B33Y 10/00; B33Y 50/02; B33Y 80/00; G06F 17/50; B29L 2031/265

(57) ABSTRACT

Conventional gas mask seals or gaskets are merely rubber flaps integral to and extending from the main body or shell of a gas mask that are conformed to the face of a wearer by tightening straps. The described gas masks comprise a separate gas mask seal and a gas mask shell. Some of the gas mask seals are individualized or customized to more tightly fit and conform to the face of the individual wearer and to provide greater comfort and protection. The gas mask seals may be made from three-dimensional image files developed directly from the wearer's facial features.

### FIELD OF THE INVENTION

The present invention is related to the art of tight fittings (i) gas masks; (ii) face pieces; (iii) nose cups; (iv) filtering face piece half mask respirators; (v) filtering face-piece full face mask respirators; (vi) half face piece elastomeric respirators; (vii) full face piece elastomeric respirators; (viii) full face piece powered air purifying respirators; (ix) half face piece powered air purifying respirator; (x) powered air purifying respirator hoods; (xi) powered air purifying, respirator helmets; (xii) half face piece atmosphere supplying respirator; (xiii) full face piece atmosphere -supplying respirator; (xiv) self-contained breathing apparatus full face piece; (xv) self-contained breathing apparatus half face piece; (xii) supplied air half face piece respirator; (xvii) supplied air full facepiece respirator; (xviii) half face piece particulate respirator; (xix) full face piece particulate respirator; (xx) full face piece chemical cartridge respirator; (xxi) half face piece chemical cartridge respirator; (xxii) full lace piece Chemical, Biological, Radiological and Nuclear (CBRN) air purifying respirator; (xxiii) half face piece Chemical, Biological, Radiological, and Nuclear (CBRN) air purifying respirator; (xxiv) Chemical, Biological, Radiological,, and Nuclear (CBRN) self-contained breathing apparatus full face piece; (xxv) full face piece, chemical, canister respirator; (xxvi) half face piece chemical canister respirator; (xxvii) closed circuit self-contained breathing apparatus full face piece; (xxviii) closed circuit self-contained breathing apparatus half face piece; (xxix) surgical half mask; (xxx) surgical full face mask; (xxxi) respirators; and (xxxii) filters (hereinafter referred to as “gas masks”) of various: design for personal protection of a wearer. The gas masks protect the wearer from the potential hazards of breathing fumes, smoke, particulates, dust, airborne liquids, aerosols, vapors, mist, smoke, fog, fumes, sprays, pathogens, spores, bacteria, biological material, pollens, viruses, mold, and other potentially dangerous pollutants, poisons, and other toxic or carcinogenic substances and/or contagious and/or infectious biological material and/or pathogens (hereinafter referred to as “contaminants”).

Gas masks provide a protected breathing volume within the gas mask to provide safe breathable, uncontaminated air for the gas mask wearer. The protected breathing volume is defined by a seal or gasket between the user's face and/or neck and the walls of the gas mask allowing the wearer to draw or receive clean breathing air from an uncontaminated source or receive filtered or purified air through a chemical, particulate, CBRN air purifying filter, canister, cartridge, and/or other “contaminant” removal device that can filter “contaminants” from the ambient environmental air as the ambient air is drawn into the breathing zone or as the environmental air is provided to the breathing zone. The protected breathing volume may be alternately connected to a supply of uncontaminated clean air for breathing or be connected to a re-circulating air cleaning system.

There are two main types of respirators as follows:
A. Air Purifying Respirators that use filters, canisters, and/or cartridges to remove vapors, gases, smoke, fumes, mists, sprays, fog, airborne liquids, contaminants, pollutants, poisons, caustic or corrosive chemicals, carcinogens, asphyxiants, particulates, bacteria, viruses, spores, mold, pollens, biological material and other potentially dangerous contaminants, pollutants, toxic substances, poisons, and/or contagious and/or infectious pathogens from the air the gas mask wearer breathes; and
B. Atmosphere Supplying Respirators that provide the gas mask wearer with clean air from an uncontaminated source of breathing air.

Gas masks may also be classified as loose fitting gas masks and tight fitting gas masks. Tight fitting gas-masks require a tight seal between the gas mask and the wearer's face and/or neck in order to work properly, if the gas mask seal of a tight fitting gas mask leaks, “contaminants” in the air may be pulled into the protected breathing volume of the gas mask facepiece and then can be inhaled by the gas mask wearer.

Gas masks comprise a seal on either an outer or inner mask providing a fight fitting seal between the gas mask and the face and/or neck of the gas mask wearer. The seals are typically integrally formed-with the walls of the gas mask. Embodiments of the gas mask provide a substantially airtight seal between the gas mask and the face and/or neck of the gas mask wearer during reduced or negative pressure in the protected breathing volume during normal, breathing and typically increased breathing during exertion.

Embodiments of the gas mask comprise gas mask gaskets or seals that are not integrally formed with the shell or walls of the gas mask. The gas mask gasket or seal hereinafter referred to as “gasket” is formed individually and separately, then may be attached to the gas mask shell or walls to form the complete gas mask with an airtight fitting seal between the gasket and the walls or shell of the gas mask.

Independently and separately formed gas mask gaskets or seals allow personal customization of the shape, dimension, contours, and fit of the gas mask gasket or seals to the unique dimensions, symmetry, contours, and facial and neck features of an individual and provide a safer, more comfortable, effective, efficient, and reliable gas mask fit and seal than mass produced standardized gas mask seals. The gasket is formed by first producing one or more 3D images of the gas mask wearer's face and neck. The 3D image of the gas mask wearer's face and neck may then be used with a 3D printer to form a gasket on one side that conforms to the shape, dimensions, contours, and features of the gas mask-wearer's face and/or neck and on the other side incorporates the fittings and connectors that interface with the body of the gas mask to obtain an airtight seal.

Embodiments of the individualized custom gas mask seal or gasket formed based on the individual's unique facial and neck characteristics, can be worn longer, more comfortably, and without fatigue or constant adjustment as is common with mass produced “one size fits everyone” type gas masks.

Embodiments of the gas mask may also comprise an inflatable gasket comprising a gasket and an integrally formed pump for inflating the gasket.

Another embodiment of the gas mask may also comprise a gasket comprising an inflatable gasket and a pump connection or air supply connection for connecting a pump or air supply for inflating the inflatable gasket. The inflatable gasket may be inflated to further conform the gasket to the gas mask wearer's face and/or neck and/or increase the sealing pressure of the gas mask gasket to the face and/or neck of the gas mask wearer and/or increase the sealing pressure of the gas mask gasket to the body of the gas mask. The inflatable gasket or seal reduces the chance that the wearer will over tighten the head and chin straps of the gas mask resulting in fatigue and/or deforming the gas mask tight fit resulting in leaks and/or discomfort for the gas mask wearer.

In one embodiment the inflatable bladder may have an over inflation indicator wanting when the bladder is folly inflated and additional inflation should be stopped.

### BACKGROUND

Gas masks are widely used personal protection devices providing temporary, long term protection for the gas mask wearer from airborne contaminants and other toxic or harmful substances in the workplace or in other special environments. Despite the common use and obviousness of necessity for gas mask use in certain circumstances and despite government regulations and the efforts of manufacturers and safety personnel to provide improved safe equipment, some tragic, events of exposure to contaminants and other harmful substances and intoxicants, asphyxiations, contaminations, and poisonings still occur. The causes of these exposures are due to (i) lack of safety equipment, (ii) use of improper equipment, (iii) improper fitting equipment and/or (iv) lack of an airtight seal between the gas mask wearer's face or neck and the sealing surface of the gas-mask or a tight-fitting seal between the gas mask wearer's face and/or neck and the gas mask's sealing surface or the wearer over tightening the mask thus restricting blood circulation and causing the respirator mask seal to buckle and leak.

An ineffective airtight seal or a locking seal or use of an improper or incorrect air purifying filter, canister, or cartridge-allows contaminants in ambient air to bypass the ah purifying filter or pass through the air purifying filter and enter the protected breathing zone. An ineffective gas mask seal may be caused by (i) an improper sized gas mask, (ii) a gas mask seal that is impaired by over tightening gas mask head straps, (iii) a corrupted or breached gas mask seal caused by facial hair or other foreign material between the gas mask wearer's face and/or neck and the gas mask seal or gasket, (iv) the gas mask wearer insufficiently or not properly fitting or tightening the gas mask straps to provide a sufficiently tight seal between the gas mask wearer's face and/or neck and sealing surface of the gas mask gasket, and/or (v) the non-standard unique dimensions, contours, symmetry, and/or facial features of the gas mask wearer's face and/or neck that do not conform well to the standardized one size fits all type of gas masks.

A gas mask may not properly seal because the seal does not conform properly to the shape of the lace of the wearer. Human faces have a variety of shapes and sizes but gas mask seals are only sized in small, medium, large and, possibly, extra-large. The size of the gas mask for a specific person may be based upon the width of their forehead, for example, but no other features. This may be insufficient to properly size and fit a gas mask. For example, FIG. 1A depicts six possible human face shapes. Additionally, genetics, weight and health may affect the shape of the face of an individual. FIG. 1A demonstrates that each of face shapes will have a different sealing surface with a typical universal type gas mask. For some face shapes the gas mask may easily and consistently seal the facial area of the individual, for other face shapes, the gas mask may properly seal the face or nasal/mouth area but not both together even when the straps are correctly tightened. In some face shapes, proper seal of the mask may be difficult to achieve especially under stressful situations when the benefits of the gas mask may be needed most.

It is well known that for tight fitting gas masks there is a need for the gas mask to be tightly fitted to the wearer's face or neck to provide an effective seal. However, over time a gas mask wearer may gain or lose weight or suffer additional changes to the wearer's facial or neck features, dimensions, symmetry and contours because of accidents, weight gain or loss, aging, medical procedures, and/or disease. Therefore, the originally selected size and style of the one size fits all standardized gas mask may no longer be capable of providing a tight-fitting seal between the gas mask wearer's changed face or neck and the gas mask. Coupled with the wearer's physical changes, over time, there is a need for continuous training in properly wearing the gas mask. Safety personnel attempt to provide sufficient training to personnel, especially firefighters, medics, and First Responders. However, in their haste to respond to an emergency situation rapidly, misunderstandings or underestimating the dangers present may cause these personnel to fail to properly fit, tighten and seal their gas mask to provide an effective seal. There are several methods: that safety personnel may use to cheek for an effective seal and a tight fit of the gas mask including (i) a subjective observational test, (ii) a negative pressure test performed by inhaling while the air intake is blocked, (iii) a qualitative fit test such as the OSHA approved method using an aerosol of stannic chloride, and (iv) a quantitative method based upon counting the number of airborne particles in the protected area of the gas mask and comparing the number of particles in the protected area of the gas mask to the number of particles outside the protected area of the gas mask. Fit tests are important. However, in fit testing, the mask is put on and the test is conducted in a more controlled and less stressful environmental than when a gas mask is put on in response to an emergency or even during regular use. A properly fitted gas mask that with a tight-fitting seal will normally protect the gas mask wearer with the proper particulate filter, air purifying canister, or cartridge that still has absorption capabilities during working time.

A wearer may try to ensure a tight fit by over tightening the straps on the mask to increase the pressure exerted on the face by the seal of the mask. Straps that, are too tight may cause portions of the face and neck piece seal to buckle or deform, allowing contaminants to enter the gas mask, Straps that are too tight may also lead to early fatigue of the face muscles and bad blood circulation over a sealed area of the face. After fatigue and discomfort sets in, the wearer may attempt to loosen the straps or adjust the position of the gas mask to relieve the discomfort and allow blood circulation. The straps may be loosened too much or the gas mask adjustment may be too extreme, causing an ineffective seal that may result in breach of the protective device.

Attempts to provide better sealing gas masks have been attempted. For example, in US Patent Application Publication No. 2013/0180529 A1 by Matich, a double seal for a face mask is being disclosed and good results have been achieved but this disclosure is related to the soft filtering face masks only. These types of masks are genuinely very soft and provide a good surface conforming fit with any face, but they cannot form an airtight seal and in some applications the protected area is too small.

U.S. Pat. No. 8,347,886 B2 issued to Grant addresses the issue of an oral/nasal mask with an integrated nasal interface. The publication does not pose or solves the issue of how to provide an effective seal for a tight-fitting gas mask.

The construction of a soft full face mask is disclosed in EP 2165739 81 to Grimsley. According to the disclosure, a gas mask with integrally molded lens could provide a universal fit and would be cheap in production. The prior art discussed in the patent typically has a separate member that is attached to the lens in a central position with a gasket seal. The benefits of this construction are following the soft integral construction with less separate parts therefore less inventory. The issue of best fit is not discussed separately believing that, a soft, face mask will provide a better fit. Nevertheless, human feces have a geometry which is far from unified to consider the softness of the face piece as a universal solution is not the best, approach as the best fit could require in a lot of cases a big pressing force from the straps therefore resulting in discomfort and fatigue and long, term face marks from blood flow restriction. Patent WO 1993000125A1 to Lars Emil Torsen discloses tight face mask having one open side for application against the face of a person thereby surrounding the nose and the mouth of said person and having a bowl-shaped housing and having gas tight elastic limiting walls connecting this hollow section filled with rigid, smooth particles of compressible material and valve connecting this cavity to the source of vacuum. The ability of this design to conform to the unique facial and neck features, dimensions, and contours of the gas mask wearer to obtain an airtight fit is in part a function of the compressed size of the individual particles used and will not achieve as uniform, continuous, and tight a fit as a fluid such as air.

In addition, such rigid, smooth particle filter after it has been shaped under a vacuum and under the influence of surrounding pressure becomes fixed in the form obtained by the particulate mass enclosed In the cavity by pressing the mask against the face. This approach results in a good match to the shape of the structure features, contours, and features of the face at a given moment in time. The drawback is that once this shape is formed, the particulate keeps or holds this form and does not respond to face movement during speech or any unavoidable, regular physiological face movements or by unconscious reflexes such as a sneeze.

There are face masks created using the best personalized approach to fitting the human face that are used for art and theatrical purposes. These masks are widely used by the cinema industry and are placed over an actor's face. It is important for such kinds of masks to be as close to the face surface as possible because the mask represents the face movements to the overlaid character mask, Recently, such masks have been the object of intensive development. For such masks, the tight fit does not provide a gas-tight seal and normally the mask covers the entire face. One method of producing such a mask presented by Pat. No. 5,180,305 to Monroe et al. An electronically created image of the head Is transferred to X-Y color printer which creates a picture with different colors used consecutively to be transferred to vacuum forming plastic, heated by infrared device, and after that vacuum-formed to create surface closely imitating the original human face. The process uses a two-dimensional image to create after a specialized surface color work three-dimensional image.

Such filler after under vacuum and under the influence of surrounding pressure is getting fixed in the form obtained by the particulate mass enclosed in the cavity by pressing the mask against the face. Such approach is in a good accordance with a real face structure in a given moment. The drawback of this solution is that once formed the particulate mass keeps this form and does not respond to face movements during speech or any unavoidable regular physiological face movements.

There exists a need tor a gas mask seal providing long term effective fit adapting to the movement of facial muscles for the periods of speech, movement, reflexes, and other changes in facial shape such as changes from fatigue or laughing. There also exists a gas mask seal that is convenient and provides an effective seal quickly and easily.

### DESCRIPTION OF THE DRAWINGS

FIG. 1A depicts the normal variation in different human face shapes, structures, symmetries, and sizes, the faces include a line indicating where the seal of a typical universal type gas-masks would fit versus producing and fitting a customized mask gasket on a specific human face, several images effaces demonstrate potential different shapes and protrusion of the chin, mouth, size and position of the nose, length and width of the face, shape and size of the forehead, position of the eye, shape of the bridge of the nose, size and shape of the cheeks, position and depth of the eye sockets, as well as other differences in facial features;

FIG. 1B depicts how a face mask fits different face shapes and how the face mask seal contacts different portions of the different faces, showing a poor fit for the regular gas mask with even normal facial deviations;

FIG. 2A depicts an embodiment of a three-dimensional face modeling apparatus and process using interconnected 3D cameras;

FIG. 2B depicts an embodiment of a three-dimensional modeling apparatus and process for a complete 3D image of a person's head including the front side and the back side;

FIG. 2C depicts an embodiment of a handheld 3D imaging camera; (the portable handheld 3D scanner is capable of creating an electronic image in a single step, in one embodiment a handheld 3D imaging camera is capable of capturing an image in 0.1 seconds and processing the image in several seconds.);

FIG. 3 depicts a method or process of computer modeling and fitting a virtual customized gasket or seal between the surface of the human virtual human face and backside of the seal or back of the lens, and also depicts a wireframe image of the shape and features of a person's face developed from a 3D modeling technique, a complementary 3D wireframe image of a gas mask seal that conforms to the face, and an image of the completed mask worn by the person face used to generate the wireframe image;

FIG. 4 depicts a side view of a 3D wire frame image of a person's face wearing a gas mask with a complementary gasket with air cavity and hand pumping bulb to inflate the air cavity and conform the gasket to the face; and

FIG. 5 shows customized best fitted areas for gas mask seals on the different faces shown in FIGS. 1A and 1B; and

FIG. 6 depicts a side view of a 3D wireframe image of an “average” human face and cross-section of a gasket with retention channels for a front lens and corrected optical lens.

### DESCRIPTION OF THE INVENTION

The present invention relates to improved gas masks and gas mask seals. Conventional gas mask seals or gaskets are merely rubber flaps extending from the main body or shell of a gas mask that are conformed to the face of a wearer by tightening straps, The seals provided by conventional gas mask are adequate tor people with average facial features but may be ill fitting for people with oddly shaped heads or more angular features, for example. Embodiments of the gas masks of the invention are individualized or customized to more tightly fit and conform to the face of the individual wearer and to provide greater comfort.

Embodiments of the gas masks of the invention include gas mask shells that do not comprise a gasket or seal but instead comprise a connection means that is capable of sealingly attach a gasket or seal to the gas mask shell. The gas mask shells may further comprise a canister, a connection for a canister, tightening straps, eye pieces and/or front lens, for example. The gaskets or seals may be attached to the gas mask shell to-customize the fit of the gas mask to the wearer thus providing a safer, more effective seal. In other embodiments, the customized gas mask seals or gaskets comprise sufficient structure to connect directly to a gas mask lens and a canister. In embodiments of the gasket, the gasket or seal may be used with full and half mask face pieces as well as with gas masks without exhalation valves and in another embodiment with full and half mask face pieces with exhalation valves.

Embodiments of the gas masks comprise gaskets or seals that are designed based upon the facial contours of the specific person that is going to wear the gas mask. The computer representation of the facial features and/or contours of the individual's, face are determined by a computer imaging method and she gas mask gasket or seal is produced to conform to the facial features and/or contours based upon this representation of the individual's face.

Further embodiments of the gas mask comprise inflatable gaskets or seals. The inflatable gaskets or seals may be inflated with a gas or liquid, typically air, to increase the size of the seal and improve the conformity of the gasket or seal to the facial features and/or contours of the face, especially soft places and to therefore follow the movement of the contours of the face during speech and mimics.

There are computer imaging applications that may be used to determine the three-dimensional shape of objects such as a face, head and/or neck of a person. The three-dimensional information may be stored in a computer file that may be manipulated or analyzed. By using this information, gas masks, and/or gas mask gaskets or seals may be snore precisely fit an individual wearer by creating the gas mask or gas mask seal based upon three-dimensional information of the facial features and/or contours of the face, head and/or neck of an individual person. Alternatively, the three-dimensional information of the shape of the face, head and/or neck of the person could also be used to choose the closest available gas mask seal from database and an inventory of available seals. Since there are many different but similar head shapes, the three-dimensional information of the shape of the face, head and/or neck could be compared with a data base of available gas masks and/or gas mask gasket or seals to determine whether an existing design would be suitable to form an effective seal for use of the gas mask. This method will provide a customized gas mask for specific facial features and contour but not an individualized gas mask design specifically for the wearer's face.

Embodiments of a gas mask may comprise a shell forming an inner protected breathing volume, an air inlet with a protective canister or a connector capable of sealably connecting a canister, cartridge, air line, compressed gas cylinder or powered air purifying filter to the shell and a connection portion for connecting a gas mask seal or gasket to the shell. The connection portion .for connecting the gas mask seal or gasket to the shell may be a permanent or temporary connector. A temporary connector would allow the gas mask shell to be reused as the gasket or seal becomes degraded such that it no longer provides an effective seal or the seal or gasket may be changed to allow the gas mask shell to be used by a different person with different sealing fit requirements or by the same person with different sealing fit requirements after weight gain or weight loss and/or after an accident or illness.

In an initial step for the design of an individualized gas mask gasket or seal, a three-dimensional image of a person's face, head and/or neck area is produced. There are several methods of producing three-dimensional images such as those- described in Three-Dimensional Facial Imaging Using a Static Light Screen and a Dynamic Subject by Robert McKeon and Patrick Flynn; those described in Three-Dimensional Face Imaging and Recognition a Sensor Design and Comparative Study by Robert McKeon and other known methods. Any of the methods may be used to create the three-dimensional image database file. The three-dimensional image database file may then be stored for use in selection and/or preparation of a gas mask or gas mask seal.

The method can create an effective, comfortable and individualized fitting gas mask. An individualized gas mask or a gas mask seal or a gas mask or gas mask seal selected form a plurality of gas masks and/or gas mask seals as the best available fit provide not only good, safe and effective fit but also the wearer should be able to wear the personal safety equipment for a long time without face muscle tiredness, wearer's face marks from intense mask pressure and other discomfort.

In one embodiment, a three-dimensional image file of the face, head and/or neck of the face of the subject is created by the use of at least two cameras simultaneously capturing two dimensional images of the face, head and neck structure of the subject, thereby creating electronic image files. The electronic image flies may be further processed to produce a three-dimensional image file representing the appropriate portions of the subject. In other methods, the three-dimensional image file may be created directly. The method could include more than two cameras or one camera that pans to various locations to capture sufficient images to create a three-dimensional virtual representation of the face.

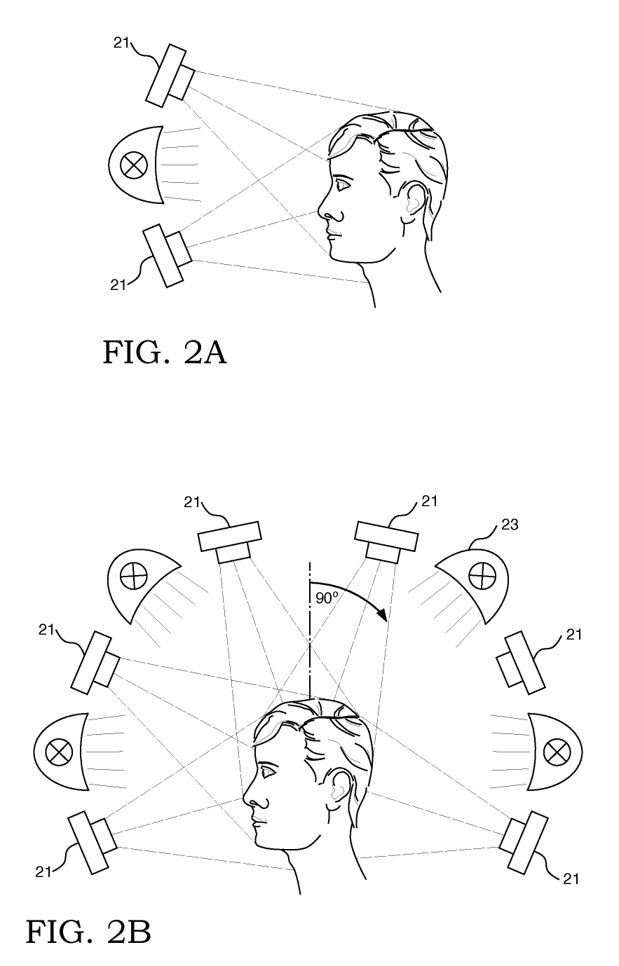

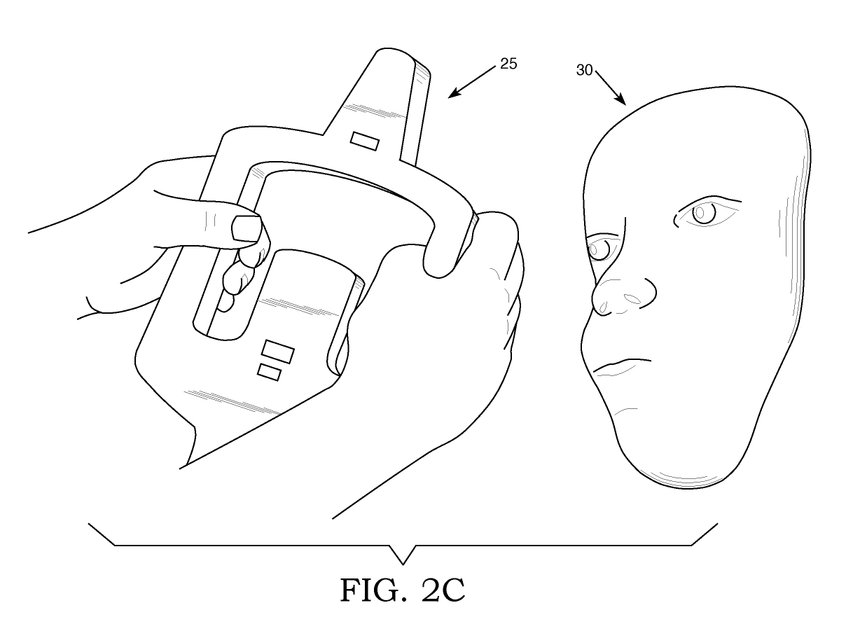

FIG. 2A is a schematic of one embodiment of a three-dimensional face modeling apparatus and process using two cameras 21 interconnected by a processing unit 22. This could be the same apparatus to produce the virtual 3D image or wire frame image of the face, neck, and/or head, for example. The cameras 21 provide different electronic image files that may be combined to produce a virtual three-dimensional image file or wireframe image of the face in the processer 22 or other processing unit. Lights 23 may be used to illuminate portions of the face 20 and create a more accurate image file.

FIG. 2C depicts portable hand held scanner imaging capturing 3D image of a face, neck, and/or head of a person. (An embodiment is capable of capturing 3D image in 0.1 sec. and processing it to the file for several seconds. Several images from all sides of the head may be combined, to create a full head virtual model allowing to create virtual full head helmet with other gas mask features as retentions/channels for optical lenses and from lens as well as retentions/channels for superimposed filters such as UV, IR and color filters for example.

The three-dimensional shape of the virtual three-dimensional electronic image is analyzed for selection or production of a gas mask or gas mask seal. The three-dimensional shape of the image may be first used to determine the best place to locate the seal to provide the best, place for an effective seal. The seal position may be located to conform to the face shape, irregular symmetry of the face, to avoid sharp features such as jaw lines or conform to prevalent cheek bones, or nose shapes, for example. The surface of the face may be analyzed visually or electronically.

A computer algorithm or other computer process generates a complementary three-dimensional image file of the portion of the face, head and/or neck of the subject as a template for the gas mask and/or gas mask seal. Alternatively, the three-dimensional image file or the complementary three-dimensional image file may be compared with a database of gas masks and/or gas mask seals that are in an inventory of gas masks and/or gas mask seals to determine an existing gas mask or gas mask seal that has a shape that would form an effective seal on the subject's face. The processes may be visually controlled on the computer monitor and specific software creates a negative three-dimensional image file of the sealing face surface. This complementary surface will represent the contact surfaces of the gasket of the gas mask or the gas mask seal.

A virtual three-dimensional image of a gas mask shell or a gas mask lens 30 may also be similarly produced. Conversely, the virtual three-dimensional image of the gas mask shell or gas mask lens 30 may be produced first and the shell or lens produced from the three-dimensional image file. FIG. 2B is a schematic of one embodiment of a three-dimensional gas mask lens 30 modeling apparatus and process using three cameras 21 interconnected by a processing unit 22. This could be the same apparatus used to produce the virtual three-dimensional image of the face, for example. The cameras provide different electronic image files that may be combined to produce a virtual three-dimensional image file of the shell and/or the lens, for example. Again, lights 23 may be used to create a more accurate image file.

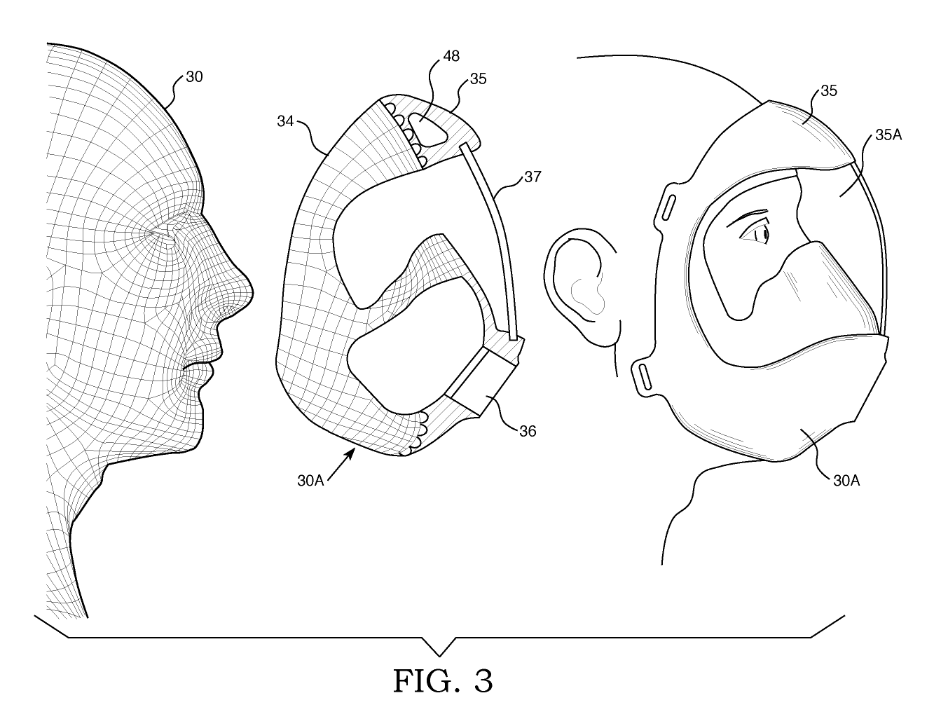

FIG. 3 depicts a rendering of the virtual production of the customized gas mask and lens. A virtual three-dimensional image of a specific face 34 is rendered, for example, as described above. An appropriate sealing surface 34 is determined either electronically or manually from the image file. The appropriate sealing surface 34 may also be determined by a combination of electronic and manual methods. For example, a processing unit may determine a first sealing surface appropriate to the face shape and to reduce sharp contours based upon an algorithm. This first sealing surface, if necessary or desired, may be adjusted manually to move the seating surface to softer portions of the face or to produce a seal that is more easily produced but just as effective for example.

A virtual gas mask seal or gasket 35 of a virtual face piece 32 may then be produced to conform closely to the sealing surface 34. The virtual face piece may further comprise scalable connections for a front lens 31 and an inlet socket 36 for connecting a canister. The front lens 31 may be permanently or removably connected to the face piece 32.

A variety of gas mask designs are available from leading manufacturers of personal protection safety equipment that may include high quality face lenses and/or a system of valves to be connected to cartridges directly or by hoses. These gas mask designs may be modified to removably receive interchangeably gas mask seals 51, Further, these gas masks can be produced without a seal but hays connection means 52 for permanently or reversibly connecting a seal to the gas mask. The connection means 52 may be made with adhesives, clamps, compression mechanism, interference fit, compression fit, tongue and groove fit, a plurality of screws, rivets or other fasteners, the plurality or screw, rivets or other fasteners may be coupled with a support backing to provide a more complete seal, or other scalable connection between the gas mask shell 53 and the gasket or seal 51. In some embodiments, the customized gasket 51 is made into an integral part of the gas mask shell 53 permanently by heat forming the shell 53 and the gasket or seal 51 together, by gluing the gasket or seal 51 together with the gas mask shell 53, or the components may be joined to the respirator mask shell by ultrasonic welding.

An objective, of the present invention is to create a gasket or seal which may be placed between the lens of the gas mask and the face surface in which the gasket will create soft and convenient sealing for long term comfortable and safe fit without excessive pressure and discomfort provided by over tighten straps or other means to attempt to fit an ill-fitting mask to a face including providing an internal vacuum.

Another objective of invention is to provide a personalized sealing contour area 34 of the gasket over the wearer's face.

Yet another objective of the invention is to design the gasket or gas mask seal such that it can accommodate face movements without losing the effective fit.

Another objective of embodiments of the gas mask with replaceable gas mask seals or gasket, wherein the gas mask seal or the gasket is designed according to facial features of the wearer to provide a low cost, highly effective gas mask.

Another objective of the invention of the gas mask with replaceable gas mask seals or gaskets on a gas mask shell is to provide an inexpensive replacement seal and fit by replacing only the bladder ox seal (not the entire mask) when the wearer's facial contours change from age, change in weight, accident or illness, or when the service life of the seal declines.

Another objective of the invention of the gas mask replaceable gas mask seal or gasket is to provide an apparatus and method for the wearer to uniformly increase the pressure of the seal fit and/or relieving the pressure of the seal fit before, during, and after use of the respirator mask as the adjustments may be required by workload, environmental conditions and hazards.

Another objective of the invention of the gas mask replaceable gas mask seal or gasket is to provide, the gasket or seal out of the optimum material for achieving a superior airtight and comfortable seal for a gas mask made of a different material that is not as suitable for obtaining a good fit but that is superior in service life and protection for the environment for which it was designed. Embodiments of the invention include a gas mask comprising a replaceable seal made of a resilient material and a gas mask shell made of a more rigid material to support the lens.

Another objective of the invention of the gas mask replaceable gas mask seal or gasket is to provide an efficient and comfortable customized gas mask fit for each individual wearer at a small cost for only a portion of the gas mask and while being able to use the existing (one size fits all) standard existing gas mask sizes produced at very low cost from high volume existing molds.

The three-dimensional images may be used 3D photos used for customizing seal or gasket cats be used to locate the exact position of the eyes in various style gas masks for the optimum positioning and placement of the following within the gas mask (possibly against the lens):

1. Welding glasses, welding glass inserts may be designed to be fitted with the gas mask based upon the three-dimensional images of the wearer's face including eye location and the three-dimensional image of the gasket and/or shell of the gas mask. The design of the support frames for the insert may be designed accurately from the images to properly position the welding glass insert to provide protection for the eyes. Additionally, the three-dimensional images may be used to design welding masks that additionally provide a protected breathing volume.

2.Heads up display, similar to Google Glass, may be incorporated into the lens or other portion of the gas mask to provide a screen for viewing information within the gas mask. The display may be positioned based upon the position of the eyes based upon the three-dimensional image of the wearer and the shape of the gas mask and lens. The heads-up display could be incorporated to prevent interference of vision at key points in the lens but still provide a good, at least peripheral view of the heads-up display. The heads-up

3.Corrective lenses 38 for improving vision may be incorporated into the lens 31 of the gas mask or be added by including inserts including a frame 39 and the corrective lenses 38 within the gas mask. In either embodiment, the focal point of the lenses may be more precisely determined the lenses shaped and located based upon the three-dimensional images described herein. The inserts frames maybe adjusted based upon the internal shape of the gas mask, gas mask shell and/or gaskets to more precisely and effectively position the lenses to optimize the vision of the gas mask wearer. Therefore, embodiments of the invention include a method of forming a gas mask shell with corrective lenses by locating the corrective lenses 38 within the gas mask shell based upon the eye location determined from a three-dimensional model of the wearers face.

4.Sunglasses and other eye protection inserts for gas masks may be similarly optimized by the methods and apparatuses described herein.

Embodiments of the gas masks comprise an adapter 52 capable of interfacing with the gasket or seal 51 portion that matches and interlocks with the shell 53 such that new or different shells can be used with the original gasket or seal. In this embodiment, a gas mask wearer may have one or more gaskets or seals produced and connected to various styles of gas mask. The adapter 52 couples forming a complete sealed interface between the gasket or seal on one side and to the gas mask shell on the other side. The adapter 52 may be permanently or replaceably connect the seal to the gas mask shell.

FIG. 6 depicts a side view of a 3d wireframe image of an “average” human face and cross-section of a gasket with retention channels 61 39 for a front lens and superimposed corrected optical lens. In the integral mask all critical distances between eyes nasal piece (top of the nasal bridge) and eyebrows area could be properly virtually adjusted and means for fixing eye correcting lenses for particular wearer may be adjusted thereby to avoid inconvenience of having glasses and wearing gas mask. Similar way different eye preventing filters such UV, IR and color filters may be imposed between or into the front lens 31 and eye correcting lenses 38.

An embodiment of a gas mask 30A comprising a shell 53 forming an inner protected breathing volume 54, an air inlet 55 with a protective canister or a connector capable, of sealably connecting a canister, air line, or self-contained air cylinder to the shell, and a connection portion 52 for connecting a gas mask seal or gasket 51 to the shell 53 may be produced as follows:

The wearer chooses the appropriate gas mask shell 53 comprising the desired lens 56, for example, without a gasket or gas mask seal having a connection portion 52 for connecting a gasket or seal 51. A computer generated three-dimensional image of the face of the wearer 60 is generated. In this embodiment, the face, head, and/or neck portion of the wearer 60 is photographed simultaneously by two digital cameras 21 situated in a distance from the wearer 60. A three-dimensional image is formed by post processing the two digital images such as by the superimposing the images of both cameras 21. An anatomically effective sealing location may then be developed on the three-dimensional image following sealing path over the face surface. The anatomically effective sealing area may be defined by avoid sharp angles, tight curves or bony areas.

In one embodiment, a three-dimensional image of the connection portion of the gas mask shell is also rendered to produce the matching portion for the seal to be connected to the shell in the computer model of the seal from the face sealing side and the shell connection portion. In this embodiment, the gas mask shell is similarly photographed and a three-dimensional model of the gas mask or the relevant portion of the gas mask shell is created. The back side of the shell, lens, or face piece is desired to have in a good resolution to provide an effective seal in all three components.

A three-dimensional Image of the gas mask seal or gasket 34 may then be produced (See FIG. 3) with one side complementary to the three-dimensional image-of the wearer's face 30 and the other side of the gasket or seal 34 being complementary to the three-dimensional image of the gas mask shell 35.

In various embodiments, the following variations may include the following:

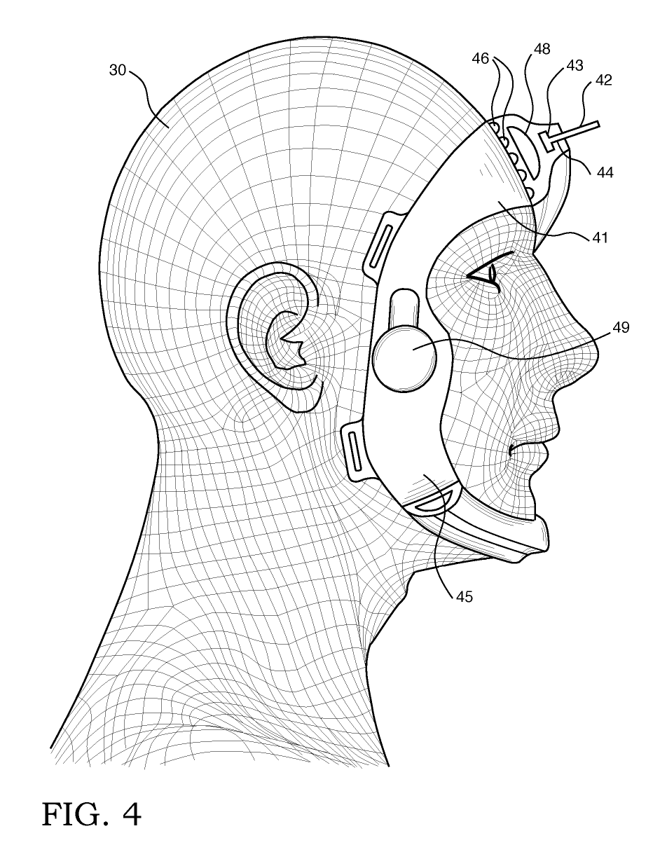

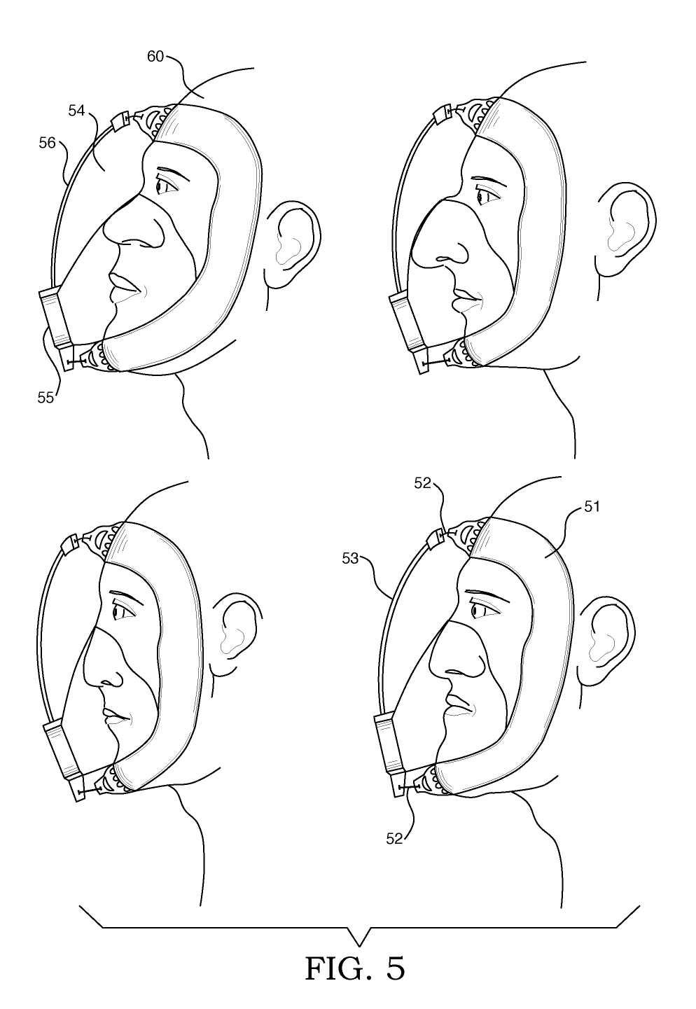

1. The face contacting surface of the gasket or seal may comprise soft multiple scaling surfaces in substantially parallel sealing surfaces 46 (as shown in FIG. 4). In certain embodiments, the sealing surfaces may be substantially longitudinally configured along the entire length of the gasket or seal 41.

2. The connection 42 between the gasket and the gas mask shell may include a ridge 43 (rim, brim) and a channel 44, wherein the ridge 43 is placed within the channel to provide a more secure and more effective seal between the gasket or seal 45 and the gas mask shell. For example, a surface of the back portion of the mask lens. A sealing line between the standard lens and gasket may comprise a channel with inside means for retentions into the gasket thereby to have better non-glue related connection seal;

3. The gasket or seal may comprise a hollow portion 48 defined in the seal or gasket adjacent to the sealing contact surface along at least a portion of the gasket. The hollow portion 48 is sealed such that it may be inflated and sealed to expand the size of the seal and increase pressure along the sealing surface of the gasket or seal In one embodiment the inflatable bladder 48 of the gasket extends all along the sealing portion of the gasket surrounding the face and filling the space between the face and back side of the gas mask shell. The inside hollow space or the inflatable bladder may be created resembling inflatable pneumatic device.

An embodiment of a gas mask 40 with an inflatable gasket bladder 48 is shown in FIG. 4. The inflatable portion may comprise an internal inflatable bladder 48. The inflatable bladder 48 or the internal hollow volume comprises an inlet connected to a pump 49 in fluid communication between the internal volume or the bladder, the pump 49 may be used to inflate the bladder or hollow volume or selectively inflate two or more separate bladders. Alternatively, the inlet may have a connection for attaching a pressurized cylinder for inflating the bladder or internal volume. The pump or pressurized cylinder allows the wearer to inflate the hollow volume or bladder 48 to the desired pressure to provide a comfortable fit and an effective seal between the gas mask and their face. In other embodiments, the gas mask seal may comprise more than one pump. For example, the seal may comprise multiple hollow volumes or bladders that may comprise separate pumps.

The pump(s) may be a hand operated pump such as squeeze pump or a cylinder pump. A valve may be included between the pump and the inlet, hollow portion or bladder to retain pumped air under pressure within the hollow portion or bladder. The pump may be a spherical or hemispherical bladder located on an exterior surface of the gas mask. In this way, the pump may be conveniently located so that the wearer can simply depress the rounded side of the rubber pump against the Other side of the pump supported by the face. The pump can then be depressed to enable the internal volume or bladder to be pressurized with air. The pump could be located on a portion of the mask adjacent to the chin, nose, cheek or forehead, for example.

In one embodiment, the pump is a bladder pump. The bladder pump may comprise a deformable central portion, a first inlet valve which prevents air from, passing from the pump to the atmosphere while allowing air to pass into the deformable central portion. The deformable central portion also comprises a connector in fluid communication with the internal volume or bladder of the seal. The pump may comprise a second one-way outlet valve which enables air to be forced into the bladder as the deformable central portion is depressed. The one-way outlet valve prevents air from returning from the bladder back to the pump as the central portion is released. Therefore, the bladder is pumped up simply by depressing the deformable central portion of the pump repeatedly until the bladder has reached a desired pressure. The bladder may include a bleed valve for bleeding air from the bladder or internal volume for removing the gasmask or if the bladder is over pressurized. In one embodiment, the gasket or bladder incorporates a pressure sensor and an over pressure indicator that becomes visible or otherwise indicates that the bladder is inflated to its maximum pressure specification and/or if the bladder is underinflated. The bleed valve is in fluid communication with the Internal volume of the bladder. The bleed valve should be closed during inflation and use of the gas mask and used only to reduce or remove pressure from the seal. The bladder bleed valve should not evacuate the bladder inside the mask, if the bladder pressure is increased during use, the bladder air will contain contaminants. If the wearer then desires to reduce the pressure in the bladder and evacuate air from the bladder seal to the interior of the mask, the wearer will be forced to breathe contaminated air. Reducing bladder pressure should result in evacuation of the bladder to ambient. There should not be a need to use bladder air to reduce pressure in the interior of the mask.

The inflatable seal may be used with individualized gaskets or incorporated into standard sized gas masks. The inflatable seal may allow a more comfortable and more effective seal using standard size gas masks. The straps of the gas mask may be tightened and then the bladders inflated to provide improved sealing around the entire perimeter of the seal or only in portions of the seal that may be prone to leakage. The bladders may be located in the neck portion, forehead portion or cheek portion, for example, or other area that, may be prone to leakage. In some embodiments, the inflatable seal with the bladder may be made into an integral part of the gas mask permanently by heat forming the shell and the gasket or seal together or by gluing the gasket, seal together with the gas mask shell or the components may be joined to the respirator mask shell by ultrasonic welding, for example.

In one embodiment the design also suggests a small chambers 46A longitudinally situated over the gasket surface and interconnected with ambient air and the hollow space into the gasket. Those chambers are build-in pumping devices. By pressing them a small amount of ambient air is introduces with very moderate pressure info the hollow chamber. The purpose of this air is to fill created Internal cavity with moderate pressurized air and thereby to correct temporarily changing skin contact by pressurizing all spots on the face seal line where face move and mimics may lead to spots with worsen contacts and leaks;

4. The virtual three-dimensional model of the gasket may be input into a computer controlled three-dimensional printer to print the gasket. The gasket may be printed using a rubber or rubber like resin, preferably a silicone resin especially designated for three-dimensional printing;

5. After printing the gasket is mounted over the back portion of the gas mask shell or nose cup;

6. The assembled mask may be cheeked for fitness by device qualitative or quantitative fit testing methods following standard procedure for mask fit test.

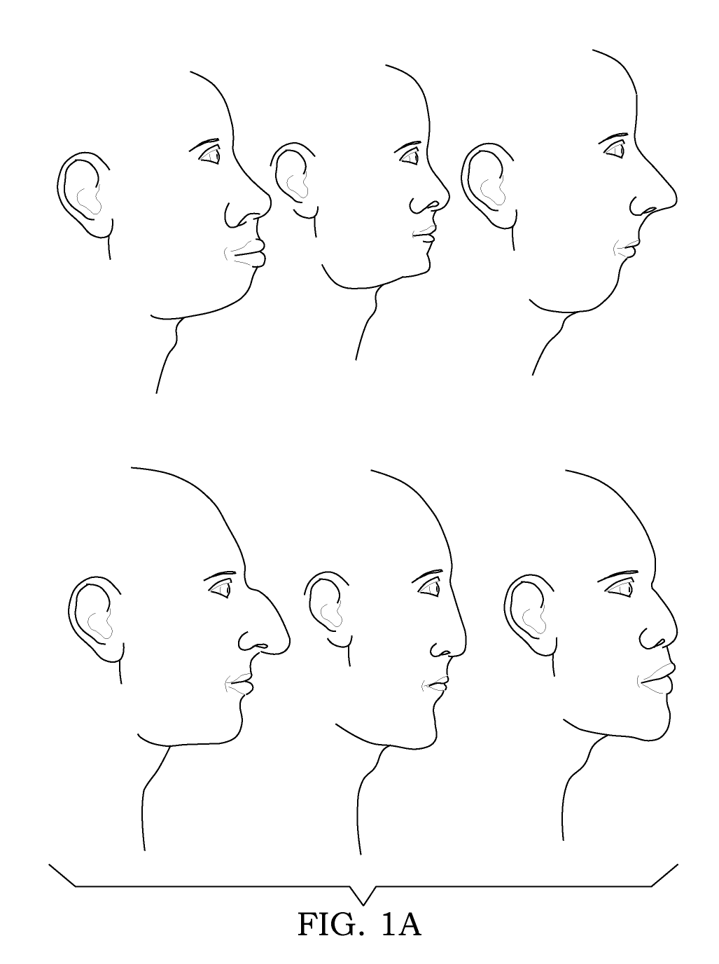

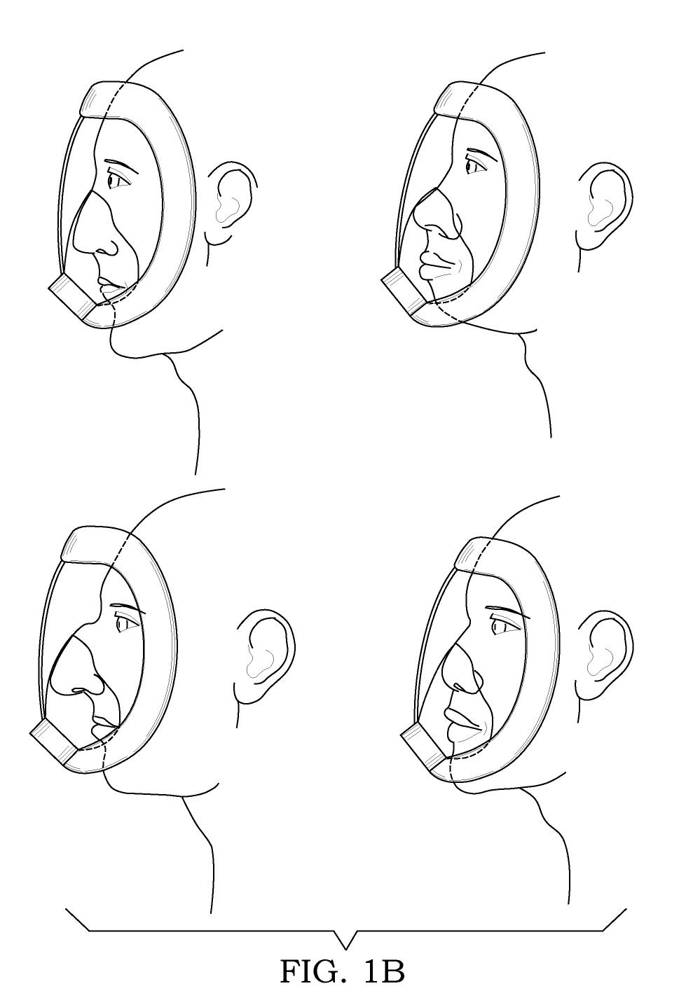

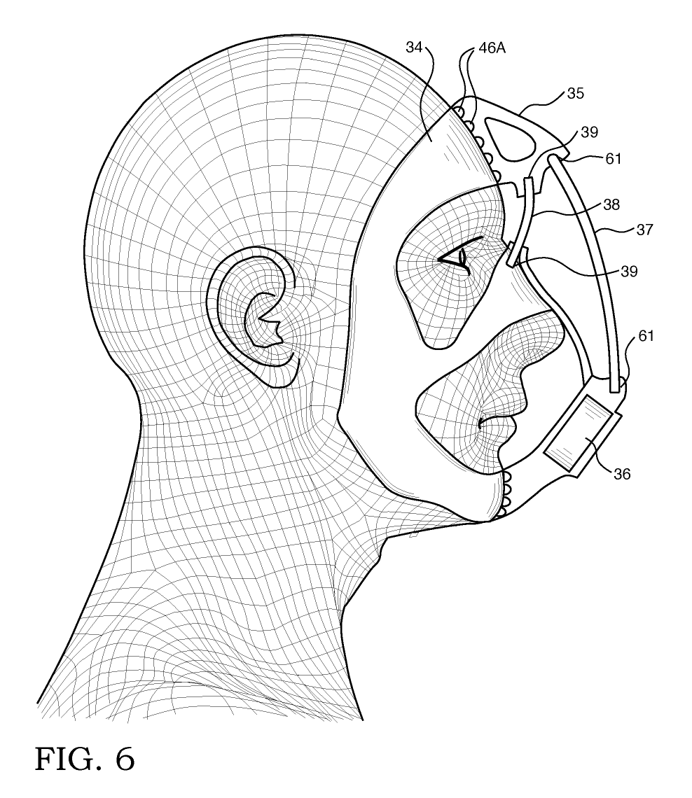

In contrast to the fit of the universal fit gas mask shown in FIG. 1, examples of customized gas mask gaskets or sealing surfaces are shown in FIG. 5. The sealing surfaces of the six faces shown in FIG. 5 are produced by embodiments of the apparatus and processes described herein to customize the gas mask sealing contour to the specific features of the various faces to produce a safe and comfortable gas mask.

All steps of embodiments of a method are generalized and may be further elaborated for more details. The present invention provides for a gasket for gas mask far superior to all existing designs in order to:

Provide custom designed fit for any type of face structure

Provide most convenient fit for extended period of time.

Alleviates the pressure needed to make good seal between face and mask.

Provides best fit in all situations of face movement conversations or mimics.

Such mounted gasket allows for easy disassembling and cleaning sealing surface if needed.

In one embodiment the respirator mask with bladder seal or gasket incorporates a valve exterior to the mask for evacuating air or liquid from the bladder if the bladder pressure against the face is too great This would be necessary if the bladder could be inflated during use by pumping the pump in the mask. Since the air pumped into the bladder from ambient during use is not filtered, it could contain contaminants and should not be evacuated into the mask.

In another embodiment, where the bladder has been filled with clean air, the bladder could be evacuated into the interior of the mask and the bladder air would, extend the useful life of the device. For example, the bladder could be filled from the inner volume of filtered air within the gas mask. In one embodiment, the inlet of the pump would draw clean air from the inner volume but the pump is activated from the exterior of the gas mask. In another embodiment, the bladder may be filled from a pressurized air cylinder. The pressurized air cylinder may be the same one that provides air to the gas mask or be a separate cylinder dedicated to fill the bladder. The extra reservoir of clean air within the bladder would be most useful to users of self-contained breathing apparatus where a specific total limited volume of breathable clean air is available in a compressed air cylinder. If the cylinder air is consumed, the person could use the reserve air in the bladder to escape to a safe area. In this configuration it would not be practical for the wearer to adjust the pressure in the bladder using the incorporated manual pump in the respirator mask during use if the manual pump draws air from the ambient (possibly contaminated air) because of the risk of exposure to contaminated air when the bladder air is evacuated into the interior of the respirator mask.

In another embodiment, the bladder includes a bladder that expands two seals; one between the molded gas mask face shield and the customized gas mask seal such that the seal between the mask and the customized gas mask will be air tight and the second seal between the customized gas mask (seal) and the wearer's face. The bladder comprises an inner channel that connects the two bladders. The pump can simultaneously pressurize the bladder and expands both seals to further conform the gasket to the user's face and to squeeze the sealing extensions of the gasket into the gas mask face shield.

In another embodiment, a connector portion (such as a protrusion, tab, rib, extension, lip or other connector), of the customized gas mask gasket is configured to extend into a standard face mask shell such that the connection (for example, a slot, channel, clamp or other connector) between the gas mask shell, and the gasket will be air tight to the gas mask shell as well as the seal between the gas mask shell (seal) and the-wearer's face. One possible way to ensure that the portion of the connector of the gasket (seal) that mates with or is inserted into a channel, for example, in the gas mask shell comprises extensions of the bladder into the connector such that the connector may also be inflated to provide the gasket with a pressurized airtight, seal against the connector portion of the gas mask shell. In some embodiments, this pressurized sealing may be accomplished without inflating the extensions from the bladder simply by inflating the bladder without having to inflate the extensions from the bladder that extend into the gas mask shell.

In one embodiment of the invention the gas mask gasket, bladder and/or seal may be fabricated out of materials that are different than the material from which the gas mask shell is manufactured in order to obtain a better seal with the replaceable shorter service life bladder while maintaining a longer service life with the gas mask's body or shell, such as using a silicon bladder with a thick neoprene rubber gas mask.

The nose cup found inside the respirator mask can additionally be a customized 3-D printed attachment for a specific wearer. A gasket or a gasket comprising a bladder could run along the edge of the nose cup thereby improving the air flow dynamics, improving fit, and improving comfort and/or possibly accommodating glasses or some other prosthetics or equipment within the respirator mask.

An embodiment of a gas mask comprising a shell forming an inner protective volume, an air inlet with a protective canister, and a connector capable of sealably connecting a canister.

This invention of incorporating an inflatable bladder within gasket in the full facepiece mask or half facepiece mask to improve the face-to-respirator seal is applicable to the following types of National Institute of Occupational Health and Safety (NIOSH) designated respirator masks and self-contained breathing apparatus masks, as well as others, as follows:
a. CBRN tail facepiece mask
b. Full facepiece mask
c. Half facepiece mask
d. Supplied air respirator mask
e. Self-contained breathing apparatus full facepiece mask
f. Chemical canister respirator mask
g. Chemical cartridge respirator mask
h. Entry respirator mask
k. Escape respirator mask
j. Pesticide respirator mask
k. Pressure demand air flow mask
l. Dust only respirator mask
m. Abrasive blasting respirator mask
n. Fume respirator mask with revivable filter
o. Mist respirator mask with replaceable filter
p. Non-powered air purifying respirator
q. Vinyl chloride respirator mask
r. Gas mask
s. Self-contained breathing apparatus half facepiece mask

In one embodiment of the invention, the respirator gas mask incorporates a bladder on the exterior edge of the mask gasket that touches the face. The bladder is fluidly connected to a valve on the exterior and/or the interior of the respirator. The exterior mounted valve is suitable for sealably connecting to a pump, positive pressure supplied air line, a pressurized cylinder of compressed air, a compressor, or other bladder inflating devices. The exterior mounted valve may also be used to evacuate pressurized bladder air.

In one embodiment of the invention, the respirator mask incorporates a valve fluidly connected to the bladder and located on the exterior of the respirator mask. The valve is for evacuating the air or liquid in the bladder to ambient in order to reduce the bladder pressure of the bladder face seal. The exterior evacuation of the bladder air is necessary if the bladder was inflated or the pressure increased via the manual pump incorporated in the respirator mask if the manual pump draws air from the ambient environment or inflated via another inflation device that draws air from the potentially contaminated area. Since the air is not filtered in these embodiments, evacuation of the bladder air, into the interior of the respirator mask, could lead to the wearer inhaling contaminated air.

In one embodiment of the invention, the respirator mask incorporates a valve that is fluidly connected to the respirator gasket bladder and located such that it evacuates the bladder air into the interior protected breathing volume of the respirator gas mask. This design cannot use the manual pump or other bladder inflation device that draws unfiltered potentially contaminated air to pressurize the bladder while the mask is worn in a potentially contaminated area. The bladder must be filled with clean, breathable air. This design is most suitable for respirator configurations that incorporate bladder inflation from a clean air source such as filtered air, air within the protected breathing volume, or cylinders of clean compressed air and respirators that are based upon a total limited air supply such as occurs with a firefighter's air pack. For such respirator configurations with clean bladder air and that evacuate air to the interior of the respirator mask, the bladder air can serve as an additional reserve air supply if the total limited supply of clean air is consumed and additional breathable air is required, in this case, the reserve bladder air can be used to escape to a safe area.

In one embodiment of the invention, the manual pump in the respirator mask is fluidly connected to canisters or cartridges or filters that are fluidly connected to the bladder. In this design, the bladder can be inflated with clean breathable air even when inflating, or pressurizing the bladder in a potentially contaminated area because the air is or has been filtered. In this design, bladder air may be used as a reserve air supply and could be consumed if an oxygen deficient environment was experienced.

In one embodiment of the invention, the N90 Series respirator half masks listed below and medical masks, and the additional masks listed below incorporate an inflatable bladder gasket that encompasses the entire edge of the respirator half mask and incorporates a valve that extends to the exterior of the mask. This valve is fluidly connected to the bladder. The valve is additionally suitable for connecting a pump, a syringe, a positive pressure airline, a compressed gas cylinder, and/or other bladder inflation devices.

The invention of the inflatable bladder gasket seal that encompasses the exterior edge of the following types of NIOSH designated types of respirator masks as follows:

a. Particulate filtering respirator

b. Elastomeric respirator masks

c. NIOSH approved particulate filtering respirator including but not limited to:

N95

Surgical N95

N100

R95

R99

R100

P95

P99

P100

HE (High Efficiency Particulate Air)

Filtering facepiece respirator—flat fold

Elastomeric respirator

Type “A” particulate respirator

Type “H” particulate respirator

Type “R” particulate respirator

Supplied air respirator mask type “CE”

Supplied air respirator mask, type “C”

Supplied air respirator mask type “BE”

Supplied air respirator mask type “B”

Supplied air respirator mask (SAR)

Supplied air hose mask respirator

Single use respirator

The inflatable bladder gasket may also be suitable for improving the fit and seal of a negative pressure demand respirator helmet by locating the bladder seal around the wearer's head at the jawline, for example.

As an additional concept, the 3D image of the wearer could be taken while the wearer is wearing eyeglasses, heating aid, or other prosthetics or equipment such that the bladder or seal is formed to accommodate these additional items that the wearer will wear during use of the gas mask or respirator and providing a more efficient and comfortable fit.

The terminology used herein is for the purpose of describing particular embodiments only, and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, ail terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. In describing the invention, it will be understood that a number of components, parts, techniques and steps are disclosed. Each of these has individual benefit and each can also be used in conjunction with one or more, or in some cases, all of the other disclosed techniques. Accordingly for the sake of clarity, this description will retrain from repeating every possible combination of the individual steps in an unnecessary fashion. Nevertheless, the specification and claims should be read with the understanding that such combinations are entirely within the scope of the invention and the claims.

The embodiments of the described gas masks, gas mask shells, gas mask gaskets and seals are not limited to the particular embodiments, components, method steps, and materials disclosed herein as such components, process steps, and materials may vary. Moreover, the terminology employed herein is used tor the purpose of describing exemplary embodiments only, and the terminology is not intended to be limiting since the scope of the various embodiments of the present invention will be limited only by the appended claims and equivalents thereof.

Therefore, while embodiments of the invention are described with reference .to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

1. A gas mask, comprising:
a gas mask shell comprising a gasket connector, a lens and a protective component connecter;
a customized gasket comprising a gas mask connector and a customized face gasket, wherein the gas mask shell connector is sealingly and removably connected to gasket connector of the gas mask shell: wherein the customized face gasket conforms to a three-dimensional image of a face shape of a wearer, and the gas mask shell and the customized gasket form a protected breathing volume for the wearer wearing the gas mask.

2. The gas mask of claim 1, wherein the customized gas mask has been designed based upon the three-dimensional model of the wearer's face, neck, and/or head,

3. The gas mask of claim 1, wherein the customized gasket defines a bladder within the customized gasket.

4. The gas mask of claim 3, comprising a pump, wherein the pump comprises an inlet and an outlet and the outlet is in fluid communication with the bladder.

5. The gas mask of claim 4, wherein the inlet draws air from the protected breathing Volume.

6. The gas mask, of claim 4, wherein the inlet draws air from an ambient environment outside the protected breathing volume.

7. The gas mask, of claim 3, comprising a valve, wherein the valve is in fluid communication with the bladder and the valve is configured to release pressure within the bladder.

8. The gas mask of claim 7, wherein the valve releases pressure within the protected breathing volume.

9. The gas mask of claim 7, wherein the valve releases pressure to an ambient environment outside of the protected breathing volume.

10. The gas mask of claim 7, comprising a second valve, wherein the valve is configured to release pressure within the protected breathing volume and the second valve is configured to release pressure to an ambient environment outside of the protected breathing volume.

11. A process of making a gas mask, comprising:
processing an electronic three-dimensional image file of at least a portion of a face to develop a gasket three-dimensional, image file with a surface complementary to a sealing portion of the three-dimensional image file of the portion of the face, neck and/or head;
preparing a gasket from the gasket three-dimensional image file, wherein the gasket comprises a customized wearer face seal and a gas mask shell connector;
connecting the gasket to a gas mask shell comprising a gasket connector, a lens and a protective component connector; wherein the gas mask shell connector is configured to sealingly and removeably connect to the gas mask shell connector.

12. The process of claim 11, comprising:
preparing the electronic three-dimensional image file by scanning the face with device capable of generating the electronic three-dimensional image file.
